(19) United States
(12) Patent Application Publication
(10) Pub. No.: US 2025/0226867 A1
(43) Pub. Date: Jul. 10, 2025

(54) A METHOD AND APPARATUS FOR CSI COMPRESSION IN TIME DOMAIN

(71) Applicant: Nokia Technologies Oy, Espoo (FI)

(72) Inventors: Filippo TOSATO, Massy (FR); Rana AHMED, Stuttgart (DE)

(21) Appl. No.: 18/853,538

(22) PCT Filed: Apr. 21, 2022
(86) PCT No.: PCT/EP2022/060517

§ 371 Date: Oct. 2, 2024

(51) Int. Cl. H04B 7/06; H04B 7/185; H04W 24/10; H04W 72/0446

(52) U.S. Cl. CPC H04B 7/0626; H04B 7/0639; H04B 7/1855; H04W 24/10; H04W 72/0446

(57) ABSTRACT

Inter-alia, a method is disclosed comprising: obtaining a time domain and/or doppler domain information, based on measuring time variations of a channel from tracking reference signal, TRS; and reporting the time domain and/or doppler domain information and a channel state information, CSI, wherein the CSI is obtained by measuring on CSI reference signal, CSI-RS. Further, a method is disclosed comprising: receiving time domain and/or doppler domain information and at least one channel state information, CSI; and reconstructing a time domain function based on the time domain and/or doppler domain information and a precoder matrix based on CSI. It is further disclosed according apparatuses, computer programs and systems.

### FIELD

Various example embodiments according to the present disclosure relate to communication networks, such as wireless radio networks comprising base stations and mobile devices or user devices (aka user equipment (UE)), communicating with each other. Specifically, various example embodiments according to the present disclosure relate to systems, apparatuses, and methods for channel state information (CSI) compression in time domain.

### BACKGROUND

Various example embodiments according to the present disclosure are related but not limited to communication networks as defined by the 3GPP standard, such as the 5G standard, also referred to as New Radio (NR).

In 5G systems, especially in FDD operations, the gNB uses downlink reference signal (e.g. CSI-RS, SSB, etc.) transmission and CSI feedback from the UE in order to obtain CSI needed for precoding of downlink (DL) data and demodulation reference signals (DMRS) over multiple layers, scheduling of resources etc.

### SUMMARY OF SOME EXEMPLARY EMBODIMENTS

For convenience, a list of abbreviations used in the following is already given at this point:
AI Artificial intelligence
CSI Channel State Information
CSI-RS Channel State Information Reference Signals
CQI Channel Quality Indicator
CRI CSI-RS Resource Indicator
CNN Convolutional Neural Network
DMRS Demodulation Reference Signals
DL Downlink
NR New Radio
CSI-RS Channel State Information-Reference Signal
CSI-IM Channel State Information-Interference Measurements
DCI Downlink Control Information
DFT Discrete Fourier Transform
DCT Discrete Cosine Transform
EVD Eigen (Value) decomposition
FDD Frequency Division Duplex
gNB Basestation in NR
RAN Radio Access Network
RRC Radio Resource Control
MAC CE MAC Control Element
MCS Modulation Coding Scheme
ML Machine Learning
MU Multi User
NN Neural Networks
IE Information Element
UCI Uplink control Signaling
UE User Equipment
UL Uplink
PMI Precoding Matrix Indicator
SU Single User
SRS Sounding Reference Signals
SVD Singular Value Decomposition
TRS Tracking Reference Signal(s)

Various example embodiments according to the present disclosure may enable time domain channel tracking and/or enable adding time-domain correlation and/or Doppler-domain information to a legacy Type-I/eType-II CSI report, e.g. without the need to measure multiple CSI-RS occasions and without requiring changes to the combination coefficients in the legacy CSI reporting. Various example embodiments may thus enable improved signalling.

According to a first exemplary aspect, a method is disclosed, the method comprising:
obtaining a time domain and/or Doppler domain information, based on measuring time variations of a channel from tracking reference signal, TRS;
reporting the time domain and/or Doppler domain information and a channel state information, CSI, wherein the CSI is obtained by measuring on CSI reference signal, CSI-RS.

For instance, according to an exemplary aspect a method is disclosed, the method comprising:
Obtaining at least one CSI reference signal, CSI-RS, for obtaining at least one CSI and obtaining at least one tracking reference signal, TRS;
Measuring time variations of a channel based on the TRS;
Obtaining a time domain and/or Doppler domain information, based on the measured time variations;
Reporting the time domain and/or Doppler domain information and the at least one channel state information, CSI, wherein the CSI is obtained by measuring on (the obtained) CSI reference signal, CSI-RS.

The above disclosed method (according to the first exemplary aspect) may for example be performed and/or controlled by an apparatus, for example a user device or UE. Both terms user device and UE are used in the following as interchangeable terms. For example, the method may be performed and/or controlled by using at least one processor of the user device or UE.

The UE may be understood as a stationary device or a mobile device (e.g., a mobile telecommunication device or a mobile phone). For example, it may be a UE of a mobile communication network, for instance a 3G, LTE/4G, 5G NR, 5G network, or future communication standards such as e.g. 6G or the like. Further, it may be for example a hand-set, a smartphone, a tablet, a laptop, or any other mobile device. In various embodiments, it may be a vehicle for travelling in air, water, or on land, e.g. a plane or a drone, a ship or a car or a truck. It may also be a robot, a sensor device, a wearable device, an Internet of Things (IoT) device, a Machine Type Communication (MTC) device, or the likes.

The means of the UE can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

For example, the UE may comprise at least one processor and at least one memory including computer program code, the at least one memory and the computer program code configured to, with the at least one processor, cause an apparatus, for example the UE, at least to perform and/or to control the method according to the exemplary aspect.

The above disclosed method (according to the first exemplary aspect) may enable time domain channel tracking and/or enable adding time-domain correlation and/or Doppler-domain information to a legacy Type-I/eType-II CSI report, e.g. without the need to measure multiple CSI-RS occasions and without requiring changes to the combination coefficients in the legacy CSI reporting. The above disclosed method (according to the first exemplary aspect) may enable improved signalling.

According to a second exemplary aspect, a method is disclosed, the method comprising:
receiving time domain and/or Doppler domain information and at least one channel state information, CSI;
reconstructing a time domain function based on the time domain and/or Doppler domain information and a precoder matrix based on CSI.

The method according to a second exemplary aspect may e.g. be performed by a network node, e.g. a gNB or a radio access network, RAN, node.

The method according to the second exemplary aspect may enable time domain channel tracking and/or enable adding time-domain correlation and/or Doppler-domain information to a legacy Type-I/eType-II CSI report, e.g. without the need to measure multiple CSI-RS occasions and without requiring changes to the combination coefficients in the legacy CSI reporting. The method may enable improved signalling.

According to a third exemplary aspect, an apparatus is disclosed, the apparatus being configured to perform and/or control and/or comprising means for and/or comprising at least one processor and at least one memory including computer program code, the at least one memory and the computer program code configured to, with the at least one processor, cause the apparatus to at least perform:
Obtaining a time domain and/or Doppler domain information, based on measured time variations;
Reporting the time domain and/or Doppler domain information and the at least one channel state information, CSI, wherein the CSI is obtained by measuring on CSI reference signal, CSI-RS.

For instance, the apparatus according to the third exemplary aspect may be or comprise a user device or a UE.

The apparatus according to the third exemplary aspect may enable time domain channel tracking and/or enable adding time-domain correlation and/or Doppler-domain information to a legacy Type-I/eType-II CSI report, e.g. without the need to measure multiple CSI-RS occasions and without requiring changes to the combination coefficients in the legacy CSI reporting. The apparatus may enable improved signalling.

According to a fourth exemplary aspect, an apparatus is disclosed, the apparatus being configured to perform and/or control and/or comprising means for and/or comprising at least one processor and at least one memory including computer program code, the at least one memory and the computer program code configured to, with the at least one processor, cause the apparatus to at least perform:
Obtaining time domain and/or Doppler domain information and at least one channel state information, CSI; and for example
reconstructing a time domain function based on the time domain and/or Doppler domain information and a precoder matrix based on CSI.

For instance, the apparatus according to the fourth exemplary aspect may be or comprise a gNB or a network node, e.g. a radio access network, RAN, node.

The apparatus according to the fourth exemplary aspect may enable time domain channel tracking and/or enable adding time-domain correlation and/or Doppler-domain information to a legacy Type-I/eType-II CSI report, e.g. without the need to measure multiple CSI-RS occasions and without requiring changes to the combination coefficients in the legacy CSI reporting. The apparatus may enable improved signalling.

According to a fifth exemplary aspect, a system is disclosed, the system comprising at least two apparatuses together performing the method according to the first and/or second exemplary aspect.

The system according to a fifth exemplary aspect may comprise a mobile entity or a part thereof and a server or a part thereof together performing the method according to the first and/or exemplary aspect. The system according to a fifth exemplary aspect may e.g. a RAN.

The system may comprise one or more apparatuses, such as an apparatus of the third and/or an apparatus of the fourth exemplary aspect, and/or a server, server cloud, a gNB, a UE, and/or a mobile terminal (e.g., a mobile telecommunication device or a mobile phone).

The system according to the fifth exemplary aspect may enable time domain channel tracking and/or enable adding time-domain correlation and/or Doppler-domain information to a legacy Type-I/eType-II CSI report, e.g. without the need to measure multiple CSI-RS occasions and without requiring changes to the combination coefficients in the legacy CSI reporting. The system may enable improved signalling.

According to a further exemplary aspect a system is disclosed comprising:
at least one apparatus according to the third exemplary aspect; and
an apparatus according to the fourth exemplary aspect.

This system may be e.g. a system according to the fifth exemplary aspect.

According to a sixth exemplary aspect, a computer program is disclosed, the computer program when executed by a processor of an apparatus causing said apparatus to perform a method according to the first and/or second exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for example a Read-Only Memory (ROM) or hard disk of a computer, or be intended for distribution of the program, like an optical disc.

The computer program according to the sixth exemplary aspect may enable time domain channel tracking and/or enable adding time-domain correlation and/or Doppler-domain information to a legacy Type-I/eType-II CSI report, e.g. without the need to measure multiple CSI-RS occasions and without requiring changes to the combination coefficients in the legacy CSI reporting. The computer program may enable improved signalling.

According to a seventh exemplary aspect, a tangible and/or non-transitory storage medium is disclosed, the tangible and/or non-transitory storage medium comprising instructions stored thereon for performing the method according to the first and/or second exemplary aspect.

The tangible and/or non-transitory storage medium according to the seventh exemplary aspect may enable time domain channel tracking and/or enable adding time-domain correlation and/or Doppler-domain information to a legacy Type-I/eType-II CSI report, e.g. without the need to measure multiple CSI-RS occasions and without requiring changes to the combination coefficients in the legacy CSI reporting. The computer program may enable improved signalling.

According to a further exemplary aspect, a method is disclosed, the method comprising the steps the apparatus of the third and/or fourth exemplary aspect is configured to perform or has means for. The method may for instance be performed and/or controlled by an/the apparatus, for instance a server, a server cloud, a gNB, and/or a mobile entity (e.g., a mobile telecommunication device or a mobile phone or a user equipment). Alternatively, this method may be performed and/or controlled by more than one apparatus, for instance a server cloud comprising at least two servers or a system of apparatus, e.g. a system comprising at least one gNB and at least one UE. For instance, the method may be performed and/or controlled by using at least one processor of an/the apparatus.

According to a further exemplary aspect, an apparatus is disclosed, the apparatus being configured to perform and/or control and/or comprising means for and/or comprising at least one processor and at least one memory including computer program code, the at least one memory and the computer program code configured to, with the at least one processor, cause the apparatus to at least perform the method of the first and/or exemplary second aspect.

According to a further exemplary aspect, a computer program product is disclosed, the computer program product when executed by a processor of an apparatus causing said apparatus to perform a method according to the first and/or second exemplary aspect.

According to a further exemplary aspect, a computer readable storage medium is disclosed, the computer readable storage medium comprising a computer program according to the sixth exemplary aspect and/or a computer program product as disclosed above.

The means of the apparatus according to any exemplary aspect may be implemented in hardware and/or software. They may comprise for instance at least one processor for executing computer program code for performing the required functions, at least one memory storing the program code, or both. Alternatively, they could comprise for instance circuitry that is designed or configured to implement the required functions, for instance implemented in a chipset or a chip, like an integrated circuit. In general, the means may comprise for instance one or more processing means or processors.

As used in this application, the term “circuitry” may refer to one or more or all of the following:
(a) hardware-only circuit implementations (such as implementations in e.g. analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

Any disclosure herein relating to any exemplary aspect is to be understood to be equally disclosed with respect to any subject-matter according to the respective exemplary aspect, e.g. relating to an apparatus, a method, a computer program, and a computer-readable medium. Thus, for instance, the disclosure of a method step shall also be considered as a disclosure of means for performing and/or configured to perform the respective method step. Likewise, the disclosure of means for performing and/or configured to perform a method step shall also be considered as a disclosure of the method step itself. The same holds for any passage describing at least one processor; and at least one memory including computer program code; the at least one memory and the computer program code configured to, with the at least one processor, cause an apparatus at least to perform a step.

Any disclosure herein relating to any exemplary aspect may enable time domain channel tracking and/or enable adding time-domain correlation and/or Doppler-domain information to a legacy Type-I/eType-II CSI report, e.g. without the need to measure multiple CSI-RS occasions and without requiring changes to the combination coefficients in the legacy CSI reporting, and/or may enable improved signalling.

In the following, exemplary features and exemplary embodiments of all aspects will be described in further detail.

According to all disclosed exemplary aspects, obtaining a time domain and/or Doppler domain information, based on measuring time variations of a channel from tracking reference signal, TRS may e.g. be or comprise:
Obtaining at least one tracking reference signal, TRS;
Measuring time variations of a channel based on the TRS; and
Obtaining a time domain and/or Doppler domain information, based on the measured time variations.

Reporting the time domain and/or Doppler domain information and a channel state information, CSI, wherein the CSI is obtained by measuring on CSI reference signal, CSI-RS may e.g. be or comprise obtaining (e.g. measuring) at least one CSI reference signal, CSI-RS, and reporting the at least one channel state information, CSI, wherein the CSI is obtained by measuring on (the obtained) CSI reference signal, CSI-RS. Reporting the time domain and/or Doppler domain information and a channel state information, CSI, wherein the CSI is obtained by measuring on CSI reference signal, CSI-RS may e.g. be or comprise:
Obtaining at least one CSI reference signal, CSI-RS, for obtaining at least one CSI and reporting the at least one channel state information, CSI.

A CSI may comprise a precoder matrix indicator (PMI) and/or a rank indicator indicating the number of reported layers.

The method according to the first and/or second exemplary aspects may be a method for reference signal, RS, measurement and reporting.

Obtaining a time domain and/or Doppler domain information, based on measuring time variations of a channel from tracking reference signal and/or reporting the time domain and/or Doppler domain information and a channel state information, CSI, wherein the CSI is obtained by measuring on CSI reference signal, CSI-RS, may e.g. be performed by a user device. Reporting may be performed by a user device and may e.g. be to a network node e.g. a radio access network, RAN, node. Reporting the time domain and/or Doppler domain information and a channel state information, CSI may be a reporting (e.g. by a user device) the time domain and/or Doppler domain information and a channel state information, CSI to a network node.

CSI reference signals (CSI-RS) may be understood as downlink reference signals intended e.g. to be used by devices to obtain downlink channel-state information (CSI) e.g. via measuring the CSI-RS. Specific instances of CSI-RS may be configured for time/frequency tracking (e.g. tracking in time and/or Doppler domain) and mobility measurements. A CSI may comprise a precoder matrix indicator (PMI) and/or a rank indicator indicating the number of reported layers. Tracking Reference Signals (TRS) may be understood as reference signals intended e.g. to assist the device in time and frequency tracking. A specific CSI-RS configuration may e.g. serve the purpose of a TRS. A Tracking Reference Signal (TRS) may be a specific CSI-RS.

Time domain and/or Doppler domain information may e.g. be understood as information related to the time domain and/or Doppler domain, respectively. The time domain information may e.g. comprise time domain (TD) correlation values. The Doppler domain information may e.g. comprise Doppler-domain (DD) codebook components. Time domain and/or Doppler domain information may e.g. comprise (e.g. only) nonzero coefficients associated to D≤Nₜ Doppler-domain (DD) codebook components, wherein Nₜ may be a number of time domain (TD) correlation values.

Time variations (e.g. of a channel) may be understood as any change over time of a signal transmitted in the channel.

A time domain function may be understood to be a function within the time domain, e.g. a function of time. A time domain function may describe how a signal changes with time, whereas a Doppler domain function may provide a representation of the time domain function in a transformed domain, after applying a transformation based on orthogonal basis functions. A time domain function may be e.g. be a time correlation function, e.g. a normalized time correlation function such as defined at a time lag tⱼ:

$$r ( {t}_{j} ) = \frac{1}{{N}_{{t}_{j}}} {\sum }_{t = {τ}_{j , 0}}^{{τ}_{j , {N}_{{t}_{j} - 1}}} \frac{h ( t ) {h ( t + {t}_{j} )}^{*}}{{\vert h ( t ) \vert}^{2}}$$

wherein tⱼ may be defined by a network (e.g. a RAN) configuring a minimum time unit, T, such that all the time lag values are a multiple of T. As an example, T=2T_{sym}, where T_{sym} is a symbol time duration and the time lag (values) may be indexed by their normalised duration, such that t₂=2T=4T_{sym}, t₅=5T=10T_{sym}, etc. In this case it holds T=t₁·h(t) may be a TRS measurement at time t. The time correlation r(tⱼ) at time lag tⱼ may be obtained by averaging (e.g. over Nₜ_{ⱼ}) measurements on an/at least one obtained TRS. r(t₂) and r(t₇) may e.g. be calculated by averaging over Nₜ_{₂}=Nₜ_{₇}=2 measurements on an/at least one obtained TRS, with {τ_{2,0}, τ_{2,1}}={4T_{sym}, 18T_{sym}} for r(t₂) and {τ_{7,0}, τ_{7,1}}={4T_{sym}, 8T_{sym}} for r(t₇). If more than one TRS is obtained (e.g. configured for time/Doppler reporting) the averaging in the time correlation function may be e.g. extended over the more than one (e.g. multiple) TRS (measurements). This may enable increasing the measurement accuracy.

The PMI may be understood as a set of precoder matrix indices corresponding to one or more precoder matrices. A precoder matrix may be formed by the combination of several components, each indicated by a subset of indices of the PMI. A precoder matrix may e.g. be or comprise a the set of weights e.g. applied to tx antennas for data/DMRS transmission. A set of rules defining how to map a PMI to corresponding precoder matrices, or a subset of PMI indices to a component of the corresponding precoder matrices may be referred to as a codebook. A codebook may be selected from a set of possible codebooks, e.g. as defined in a standard based on e.g. a codebook type, a possible number of transmission layers for the downlink transmission and CSI reporting configuration parameters such as antenna panel dimensions.

According to an exemplary embodiment of the method according to the first exemplary aspect and/or the apparatus according to the third exemplary aspect, the method further comprises and/or the apparatus further comprising means for and/or the at least one memory and the computer program code further configured to, with the at least one processor, cause the apparatus to at least perform:
Obtaining (e.g. receiving or configuring) a first configuration to report Nt time domain correlation values calculated from the TRS, and/or to report nonzero coefficients associated to D≤Nt Doppler domain codebook components, where Nt and D are integers; and/or
Obtaining (e.g. receiving or configuring) a second configuration to provide the TRS-based time domain and/or Doppler domain measurements in a wideband fashion or a subband fashion.

Obtaining a first and/or second configuration may be a receiving or configuring (e.g. by a network node) a first and/or second configuration. For instance, a user device may receive a first and/or second configuration, e.g. from a network node.

According to an exemplary embodiment of all exemplary aspects, a/the Doppler domain codebook components comprise discrete cosine transform, DCT, based and/or discrete Fourier transform, DFT, based codebook components.

According to an exemplary embodiment of the method according to the first exemplary aspect and/or the apparatus according to the third exemplary aspect, the time domain and/or Doppler domain information and the CSI are reported to a/the network node separately. For instance CSI and, in particular, PMI (precoder matrix indicator) may be encoded separately from the time and/or Doppler domain information and may e.g. be used without it.

As a further exemplary embodiment an apparatus, e.g. a user device or UE, may report separate time and/or Doppler domain information (e.g. comprising time and/or Doppler quantities) for multiple FD basis components. For instance, a time domain information may be a subband time information. Time domain information (e.g. subband time information) and/or Doppler information may for instance be provided by reporting separate correlation and/or Doppler coefficients for different FD basis components. For instance, a user device may report separate time and/or Doppler domain quantities for multiple FD basis components.

According to an exemplary embodiment of the method according to the first exemplary aspect and/or the apparatus according to the third exemplary aspect, the TRS based time domain and/or Doppler domain information are reported for a respective (e.g. each) layer of precoder matrix indicator reported in the CSI.

According to an exemplary embodiment of the method according to the second exemplary aspect and/or the apparatus according to the fourth exemplary aspect, the method further comprises and/or the apparatus further comprising means for and/or the at least one memory and the computer program code further configured to, with the at least one processor, cause the apparatus to at least perform:

Providing a first configuration (e.g. configuring; e.g. by the network node, e.g. to a user device) to report Nt time domain correlation values calculated from the TRS, and/or to report nonzero coefficients associated to D≤Nt Doppler domain codebook components, where Nt and D are integers.

According to an exemplary embodiment of the method according to the first exemplary aspect and/or the apparatus according to the third exemplary aspect, the method further comprises and/or the apparatus further comprising means for and/or the at least one memory and the computer program code further configured to, with the at least one processor, cause the apparatus to at least perform:
Obtaining at least one CSI reference signal, CSI-RS, for obtaining at least one CSI and obtaining at least one tracking reference signal, TRS;
Measuring time variations of a channel based on the TRS.

The CSI may be obtained by measuring on (the obtained) at least one CSI reference signal, CSI-RS. Obtaining at least one CSI reference signal, CSI-RS, for obtaining at least one CSI may comprise measuring the obtained at least one CSI reference signal.

According to an exemplary embodiment of the method according to the first exemplary aspect and/or the apparatus according to the third exemplary aspect, reporting the time domain and/or Doppler domain information comprises reporting Nt time domain correlation values calculated from the TRS, and/or reporting nonzero coefficients associated to D≤Nt Doppler domain codebook components, where Nt and D are integers.

According to an exemplary embodiment of the method according to the first exemplary aspect and/or the apparatus according to the third exemplary aspect, reporting the time domain and/or Doppler domain information is performed in a wideband fashion or a subband fashion.

According to an exemplary embodiment of the method according to the first exemplary aspect and/or the apparatus according to the third exemplary aspect, reporting the time domain and/or Doppler domain information comprises reporting nonzero coefficients associated to D≤Nt Doppler domain codebook components, where Nt and D are integers, wherein the Doppler domain codebook components comprises discrete cosine transform, DCT, based and/or DFT based codebook components.

According to an exemplary embodiment of the method according to the first exemplary aspect and/or the apparatus according to the third exemplary aspect, the time domain and/or Doppler domain information and the CSI are reported separately.

According to an exemplary embodiment of the method according to the first exemplary aspect and/or the apparatus according to the third exemplary aspect, reporting the time domain and/or Doppler domain information is performed for a respective (e.g. each) layer of precoder matrix indicator reported in the CSI.

According to an exemplary embodiment of the method according to the second exemplary aspect and/or the apparatus according to the fourth exemplary aspect, the method further comprises and/or the apparatus further comprising means for and/or the at least one memory and the computer program code further configured to, with the at least one processor, cause the apparatus to at least perform:
Providing a second configuration (e.g. configuring; e.g. by the network node, e.g. to a user device) to provide the TRS-based time domain and/or Doppler domain measurements in a wideband fashion or a subband fashion.

Providing a first and/or second configuration may be or comprise sending said configuration, e.g. by a network node to a user device.

According to an exemplary embodiment of the method according to the second exemplary aspect and/or the apparatus according to the fourth exemplary aspect, the Doppler domain codebook components comprises discrete cosine transform, DCT, based and/or DFT based codebook components.

According to an exemplary embodiment of the method according to the second exemplary aspect and/or the apparatus according to the fourth exemplary aspect, the time domain and/or Doppler domain information and the CSI are obtained (e.g. from a user device) separately.

According to an exemplary embodiment of the method according to the second exemplary aspect and/or the apparatus according to the fourth exemplary aspect, the TRS based time domain and/or Doppler domain information are obtained (e.g. from a user device) for each layer of precoder matrix indicator of the CSI.

According to an exemplary embodiment of the method according to the second exemplary aspect and/or the apparatus according to the fourth exemplary aspect, the method further comprises and/or the apparatus further comprising means for and/or the at least one memory and the computer program code further configured to, with the at least one processor, cause the apparatus to at least perform:
Providing a first configuration to a further apparatus, to report Nt time domain correlation values calculated from a tracking reference signal, TRS, and/or to report nonzero coefficients associated to D≤Nt Doppler domain codebook components, where Nt and D are integers.

The apparatus according to the fourth exemplary aspect may e.g. be a network node. The further apparatus may e.g. be a user device.

According to an exemplary embodiment of the method according to the second exemplary aspect and/or the apparatus according to the fourth exemplary aspect, the method further comprises and/or the apparatus further comprising means for and/or the at least one memory and the computer program code further configured to, with the at least one processor, cause the apparatus to at least perform:
Providing a second configuration to the further apparatus, to provide TRS-based time domain and/or Doppler domain measurements in a wideband fashion or a subband fashion.

According to an exemplary embodiment of the method according to the second exemplary aspect and/or the apparatus according to the fourth exemplary aspect, the method further comprises and/or the apparatus further comprising means for and/or the at least one memory and the computer program code further configured to, with the at least one processor, cause the apparatus to at least perform:
Reconstructing a precoder based on the obtained time domain and/or doppler domain information.

For instance, the CSI may comprise the time domain and/or doppler domain information.

According to an exemplary embodiment of the method according to the second exemplary aspect and/or the apparatus according to the fourth exemplary aspect, the time domain and/or Doppler domain information and the CSI are obtained separately.

According to an exemplary embodiment of the method according to the second exemplary aspect and/or the apparatus according to the fourth exemplary aspect, the TRS based time domain and/or Doppler domain information are obtained for each layer of precoder matrix indicator of the CSI.

According to an exemplary embodiment of all exemplary aspects, a method for measuring time variations of a channel from TRS signals is disclosed, comprising e.g. reporting (corresponding) channel state information.

According to an exemplary embodiment of all exemplary aspects, obtaining a time domain and/or Doppler domain information, based on measuring time variations of a channel from tracking reference signal, TRS and/or measuring time variations of a channel based on the TRS may comprise determining a variation in time of (the) nonzero combination coefficients e.g. of a legacy Type-I or Type-II PMI.

According to an exemplary embodiment of all exemplary aspects, reporting and/or obtaining the time domain and/or Doppler domain information may comprise reporting and/or obtaining (e.g. only) nonzero combination coefficients.

According to an exemplary embodiment of all exemplary aspects, reporting and/or obtaining the time domain and/or Doppler domain information may comprise reporting and/or obtaining a report comprising time correlation at predetermined time lags and/or transformed coefficients associated to a set of basis components taken from a codebook, e.g. a discrete cosine transformed basis.

According to an exemplary embodiment the method according to the first exemplary aspect further comprises and/or the apparatus according to the third exemplary aspect is configured to perform and/or comprises means for and/or the at least one memory and the computer program code further configured to, with the at least one processor, cause the apparatus to at least perform:
Determining a maximum time correlation lag (t_{N}_{₄}₋₁) at least partially based on a maximum time separation of the obtained (e.g. measured) TRS (resources); and optionally at least partially based on the time unit T=t₁ corresponding to the fraction t_{N}_{₄}₋₁/N₄, where N₄ is a dimension of a/the codebook, and T is a multiple of a symbol duration T_{sym}.

According to an exemplary embodiment of all exemplary aspects, a codebook may e.g. be a codebook configured for the compression of the time correlation formed by discrete cosine transformed basis.

According to an exemplary embodiment of all exemplary aspects, (e.g. time domain and/or Doppler domain) information may be used to determine the variation in time of the nonzero combination coefficients of a legacy Type-I or Type-II PMI. TRS time measurements may be e.g. reported as time correlation at predetermined time lags or as transformed coefficients associated to a set of basis components taken from a codebook. The maximum time correlation lag, t_{N}_{₄}₋₁ may e.g. be determined by the maximum time separation of the measured TRS resources and the time unit T=t₁ may correspond to the fraction t_{N}_{₄}₋₁/N₄, where N₄ is the codebook dimension, and T is a multiple of a symbol duration T_{sym}. The codebook e.g. configured for the compression of the time correlation may e.g. be formed by (a) discrete cosine transformed basis.

The features and example embodiments described above may equally pertain to the different aspects.

It is to be understood that the presentation in this section is merely by way of examples and non-limiting.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### BRIEF DESCRIPTION OF THE DRAWINGS

The figures show:

FIG. 1 a schematic high-level block diagram of an exemplary system;

FIG. 2a a flowchart showing an example embodiment of a method according to the first exemplary aspect;

FIG. 2b a flowchart showing an example embodiment of a method according to the first exemplary aspect;

FIG. 3 a flowchart showing an example embodiment of a method according to the second exemplary aspect;

FIG. 4 an exemplary measurement timeline for a legacy CSI report;

FIG. 5 an exemplary resource element locations occupied by a TRS occasion;

FIG. 6a exemplary time correlations measured from the exemplary TRS resources of FIG. 5;

FIG. 6b exemplary time correlations measured from the exemplary TRS resources of FIG. 5;

FIG. 7 high level block diagram of an exemplary method according to the first exemplary aspect and an exemplary method according to the second exemplary aspect;

FIG. 8 high level block diagram of an exemplary method according to the first exemplary aspect and an exemplary method according to the second exemplary aspect;

FIG. 9 high level block diagram of an exemplary method according to the first exemplary aspect and an exemplary method according to the second exemplary aspect;

FIG. 10 high level block diagram of an exemplary method according to the first exemplary aspect and an exemplary method according to the second exemplary aspect;

FIG. 11 a schematic block diagram of an example embodiment of an apparatus according to the first aspect and/or an example embodiment of an apparatus configured to perform the method according to the second exemplary aspect.

### DETAILED DESCRIPTION OF SOME EXEMPLARY EMBODIMENTS

The following description serves to deepen the understanding and shall be understood to complement and be read together with the description as provided in the above summary section of this specification. Some aspects may have a different terminology than e.g. provided in the description above. The skilled person will nevertheless understand that those terms refer to the same subject-matter, e.g. by being more specific. For instance, time domain and/or Doppler domain may be referred to as time/Doppler or TD/DD. Time domain and/or Doppler domain information may be referred to as time-domain correlation/Doppler-domain information. Discrete cosine transform, DCT, codebook components may be referred to as a DCT basis components or DCT basis vectors.

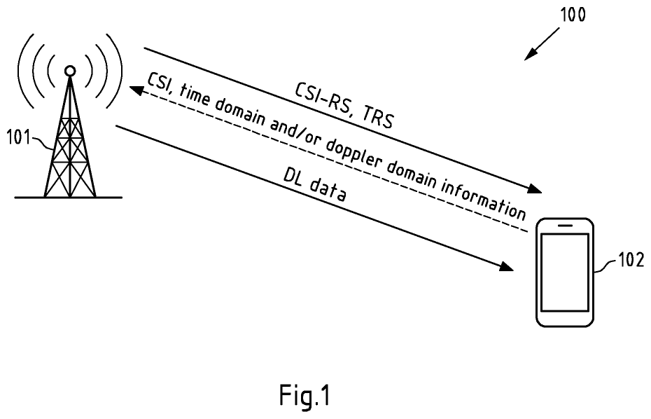

FIG. 1 is a schematic high-level block diagram of a system 100 according to all exemplary aspects. System 100 comprises one or more apparatuses 101 representing e.g. apparatuses according to the second exemplary aspect, and another apparatus 102 representing e.g. an apparatus according to the first exemplary aspect. The apparatuses 101, 102 may for instance be part of a mobile communication network or RAN.

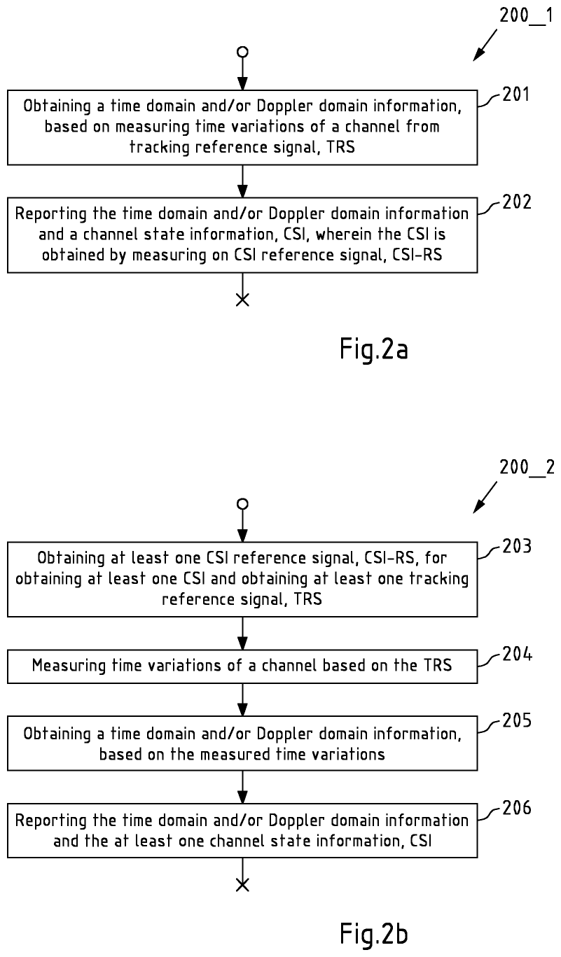

FIG. 2a and FIG. 2b are flowcharts showing exemplary embodiments of a method according to the first exemplary aspect. The flowchart 200_1 and/or 200_2 may for instance be performed by at least one apparatus 102, e.g. a user device. Additionally or alternatively, flowchart 200_1 and/or 200_2 may be performed by a system 100 comprising more than one apparatus.

In FIG. 2a, in a first step 201 of flowchart 200_1, a time domain and/or Doppler domain information is obtained, e.g. by a user device, based on measuring time variations of a channel from tracking reference signal, TRS. TRS may be a specific CSI-RS.

In a second step 202, the time domain and/or Doppler domain information and a channel state information, CSI is reported e.g. by a user device e.g. to a network node, wherein the CSI is obtained by measuring on CSI reference signal, CSI-RS.

In FIG. 2b, in a first step 203 flowchart 200_2, at least one CSI reference signal, CSI-RS, for obtaining at least one CSI and obtaining at least one tracking reference signal, TRS are obtained, e.g. by a user device 102. The obtained CSI-RS may be measured to obtain (i.e. for obtaining or to gather or to measure) at least one CSI.

In a second step 204, time variations of a channel based on the TRS are measured, e.g. by a user device 102.

In a third step 205, a time domain and/or Doppler domain information is obtained, based on the measured time variations, e.g. by a user device 102.

In a fourth step 206, the time domain and/or Doppler domain information and the at least one channel state information, CSI, is reported, e.g. by a user device 102 e.g. to a network node 101.

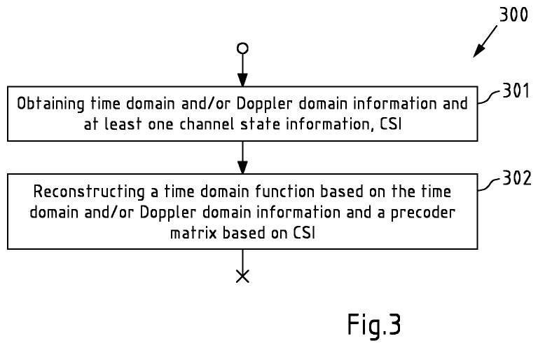

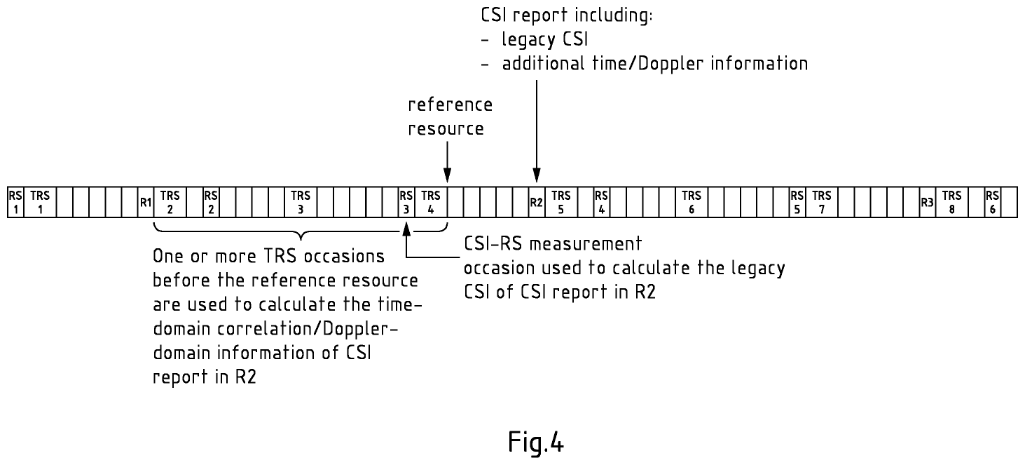

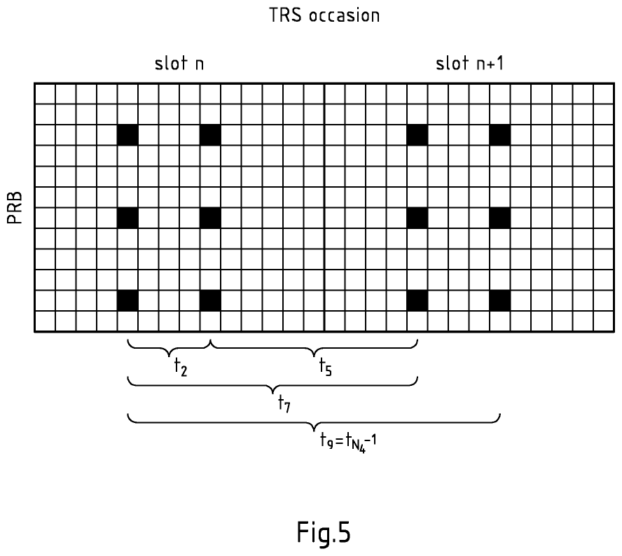

FIG. 3 is a flowchart showing an exemplary embodiment of a method according to the second exemplary aspect. The flowchart 300 may for instance be performed by at least one apparatus 101, e.g. a network node or gNB 101. Additionally or alternatively, flowchart 300 may be performed by a system 100 comprising more than one apparatus, e.g. comprising a server or a server cloud.

In a first step 301 flowchart 300, time domain and/or Doppler domain information and at least one channel state information, CSI are obtained by e.g. a network node, e.g. obtained from a user device 102.

In a second step 302, a time domain function is reconstructed based on the time domain and/or Doppler domain information and a precoder matrix based on CSI, e.g. by a network node.

In NR, a gNB may transmit DL reference signal CSI-RS such that the UE may e.g. measure the DL channel. Based on this measurement, the UE may determine (e.g. calculate) CSI quantities for reporting based on either Type-I or Type-II codebooks. CSI quantities configured for reporting may include precoder matric indicator (PMI) and corresponding channel quality indicator (CQI). Type-I codebooks may e.g. provide a coarse representation of the precoder, e.g. indicated by the precoder matrix indication (PMI), by selecting a single DFT beam per layer per subband. The same beam may be used in both polarisations of the transmit antenna array, with a co-phasing factor between the two polarisations. Type-II codebooks may provide a richer precoder representation, by e.g. representing the precoding weights per layer per subband as a linear combination of L DFT beams.

For Type-I and Type-II (e.g. Rel-15) codebooks, the precoding matrix, per layer, and across at least two (e.g. all) subbands e.g. configured for reporting, e.g. for subband reporting, may follow the codebook structure:

$$W = {W}_{1} {W}_{2}$$

where W₁ may be a matrix of wideband DFT beams, of size 2N₁N₂×2L and may be formed by L orthogonal vectors/beams per polarization p, e.g. selected from a set of oversampled 2D DFT beams, where N₁ and N₂ may be the number of antenna ports in horizontal and vertical dimensions of the transmit rectangular array. This operation may achieve a compression in the spatial domain (SD), hence the resulting 2L beams may also be referred to as SD components. In the antenna domain, there may e.g. exist a transformed duality between a two-dimensional rectangular antenna array domain and a two-dimensional angular domain, such that a 2D DFT-beam may be associated with a pair of discrete angles in azimuth and elevation. W₂ may be a subband matrix of size 2L×N₃ containing, for e.g. a respective (e.g. each) of the N₃ subbands, the beam selection and/or co-phasing factors between the two polarisations, in e.g. case of Type-I. For e.g. Type-II, W₂ may contain the complex-valued combination coefficients of the L beams for each polarisation.

For above disclosed Type-II, the precoder vector for layer l=1, . . . , v and sub-band s=0, . . . , N₃-1 may e.g. be expanded as follows

$${W}_{S}^{l} = \frac{1}{\sqrt{{N}_{1} {N}_{2} {γ}_{s , l}}} [ \begin{matrix}{\sum }_{i = 0}^{L - 1} {v}_{{m}_{1}^{( i )} , {m}_{2}^{( i )}} {p}_{l , i , s} φ \\ {\sum }_{i = 0}^{L - 1} {v}_{{m}_{1}^{( i )} , {m}_{2}^{( i )}} {p}_{l , i + L , s} {φ}_{l , i + L , s}\end{matrix} ] , l = 1 , 2 , s = 0 , … , {N}_{3} - 1$$

where Wₛ^{l} is of size 2N₁N₂×1, vₘ_{₁}_{⁽ⁱ⁾}ₘ_{₂}_{⁽ⁱ⁾} is the i-th SD basis component of size 2N₁N₂×1, p_{l,i,s}=p_{l,i}⁽¹⁾p_{l,i,s}⁽²⁾ is the subband amplitude and φ_{l,i,s} the subband phase of the combination coefficient for SD component i, layer l and subband s, and γ_{s,l} is a normalisation factor to ensure unit norm of the precoding vectors.

For eType II (e.g. Rel-16) and FeType-II (further enhanced Type-II; Rel-17) codebooks, a compression operation may be added in the frequency domain, such that e.g. the precoding matrix, per layer, and across at least two (e.g. all) subbands configured e.g. for reporting, may follow the codebook structure:

$$W = {W}_{1} {W}_{2} {W}_{f}^{H}$$

where W_{f} may be a matrix of FD basis components of size N₃×M and may be formed by M orthogonal vectors selected from a DFT codebook. W₂ may be a 2L×M matrix containing combining coefficients for a respective (e.g. each) pair of SD and FD basis components. The FD basis components may e.g. refer to components in the delay domain, which may be the dual transformed domain of the frequency (i.e. subband) domain. Hence, the FD basis components may be delay-domain basis components. The above disclosed FeType-II codebook may be a new port selection codebook for partial UL/DL channel reciprocity in FDD, which may e.g. exploit the gNB's estimation of dominant beams and delays to e.g. precode the CSI-RS ports and for instance simplify the FD compression operation at the UE.

For above disclosed eType-II, the precoder vector for layer 1=1, . . . , v and sub-band s=0, . . . , N₃−1 may be expanded as follows:

$$\begin{matrix}{W}_{S}^{l} = \frac{1}{\sqrt{{N}_{1} {N}_{2} {γ}_{s , l}}} [ \begin{matrix}{\sum }_{i = 0}^{L - 1} {v}_{{m}_{1}^{( i )} , {m}_{2}^{( i )}} {\sum }_{f = 0}^{M - 1} {y}_{s , l}^{( f )} {p}_{l , i . f} {φ}_{l , i , f} \\ {\sum }_{i = 0}^{L - 1} {v}_{{m}_{1}^{( i )} , {m}_{2}^{( i )}} {\sum }_{f = 0}^{M - 1} {y}_{s , l}^{( f )} {p}_{l , i + L , f} {φ}_{l , i + L , f}\end{matrix} ] \\ l = 1 , 2 , 3 , 4 , s = 0 , … , {N}_{3} - 1\end{matrix}$$

where Wₛ^{l} may be of size 2N₁N₂×1 and γ_{s,l}^{(f)} may be the s-th element of the f-th FD basis component, γₗ^{(f)}, of size N₃×1.

In this codebook structure, UE may e.g. report one complex-valued combination coefficient per layer and per polarisation, p_{l,i,s}φ_{l,i,f}, for at least one (e.g. each) pair of SD-FD basis component. The eType-II precoder may for example be represented for the 2N₁N₂ transmit antennas and N₃ subbands as a 2N₁N₂·N₃×1 vector formed e.g. by a linear combination of L·M SD-FD basis component pairs that may be given by yₗ^{(f)}⊗vₘ_{₁}_{⁽ⁱ⁾}ₘ_{₂}_{⁽ⁱ⁾}, where ⊗ denotes the Kronecker product. The 2N₁N₂·N₃×1 precoder for eType-II may be rewritten as follows, where precoder normalization is omitted, for simplicity:

$${W}^{l} = [ \begin{matrix}{\sum }_{i = 0}^{L - 1} {\sum }_{f = 0}^{M - 1} {p}_{l , i . f} {φ}_{l , i , f} ( {y}_{l}^{( f )} ⊗ {v}_{{m}_{1}^{( i )} , {m}_{2}^{( i )}} ) \\ {\sum }_{i = 0}^{L - 1} {\sum }_{f = 0}^{M - 1} {p}_{l , i + L , f} {φ}_{l , i + L , f} ( {y}_{l}^{( f )} ⊗ {v}_{{m}_{1}^{( i )} , {m}_{2}^{( i )}} )\end{matrix} ] , l = 1 , 2 , 3 , 4$$

For instance in Rel-18, a new enhancement of CSI reporting may e.g. be considered by exploiting the time-domain correlation/Doppler-domain information to e.g. assist DL precoding, according the following description (as e.g. described in 3GPP RAN #94-e):

(First) studying, and if justified, specifying CSI reporting enhancement for high/medium UE velocities by exploiting time-domain correlation/Doppler-domain information to assist DL precoding, targeting FR1, as follows:
Rel-16/17 Type-II codebook refinement, without modification to the spatial and frequency domain basis
UE reporting of time-domain channel properties measured via CSI-RS for tracking

Time-domain correlation and Doppler-domain spectrum may e.g. form a third “dual-domain” pair, besides the antenna/angle and frequency/delay that may e.g. be considered in Rel-15/16/17.

A method (e.g. mechanism) for CSI measurement and reporting may be provided, which may include Doppler-domain compression. The method may be based on UE's measurement of a burst of, e.g. N₄ CSI-RS resources, UE's selection of, e.g. D Doppler-domain basis components and the configuration of a DFT codebook for the selection of Doppler-domain basis components. The legacy eType II CSI feedback may be modified by e.g. reporting a single set of nonzero combination coefficients for the three codebook-based basis components (spatial, delay and Doppler). Hence, a UE may report one combination coefficient for a respective (e.g. each) selected triplet of spatial, delay, Doppler components. To obtain such a single combination coefficient, the method may comprise measuring spatial, delay and Doppler components on the same CSI-RS signal, which may be repeated in a burst to allow joint determination of spatial, delay and Doppler basis components. For instance, the precoder may for the 2N₁N₂ transmit antennas, N₃ subbands and N₄ time samples be represented as a 2N₁N₂·N₃·N₄×1 vector formed e.g. by a linear combination of L. M. D SD-FD-Doppler basis component triplets given e.g. by uₗ^{(d)}⊗yₗ^{(f)}⊗vₘ_{₁}_{⁽ⁱ⁾}ₘ_{₂}_{⁽ⁱ⁾}, where uₗ^{(d)} denotes a Doppler-domain basis component. The 2N₁N₂·N₃·N₄×1 precoder may be rewritten as follows, where precoder normalisation is omitted for simplicity

$${W}^{l} = [ \begin{matrix}{\sum }_{i = 0}^{L - 1} {\sum }_{f = 0}^{M - 1} {\sum }_{d = 0}^{D - 1} {p}_{l , i . f , d} {φ}_{l , i , f , d} ( {u}_{l}^{( d )} ⊗ {y}_{l}^{( f )} ⊗ {v}_{{m}_{1}^{( i )} , {m}_{2}^{( i )}} ) \\ {\sum }_{i = 0}^{L - 1} {\sum }_{f = 0}^{M - 1} {\sum }_{d = 0}^{D - 1} {p}_{l , i + L , f , d} {φ}_{l , i + L , f , d} ( {u}_{l}^{( d )} ⊗ {y}_{l}^{( f )} ⊗ {v}_{{m}_{1}^{( i )} , {m}_{2}^{( i )}} )\end{matrix} ] , l = 1 , 2 , 3 , 4.$$

A UE may be configured to determine (e.g. calculate) a legacy Type-I or Type-II from a CSI-RS resource. Additionally, the UE may be configured to measure and report time correlation or Doppler coefficients from one or more TRS occasions. TRS are a special type of CSI-RS e.g. intended for tracking CFO (carrier frequency offset between gNB and UE carrier frequencies) and TFO (timing frequency offset, i.e. clock period offset used for sampling at gNB and UE) and for Doppler related measurements. Both CFO and TFO may be caused by differences in the oscillator frequency between gNB and UE, whereas Doppler spread may be caused primarily by UE's mobility. A TRS resource set may contain either two or four periodic CSI-RS resources with periodicity 2^{μ}Xₚ slots where Xₚ=10, 20, 40, or 80 and where u is related to the subcarrier spacing (SCS), i.e. μ=0, 1, 2, 3, 4 for 15, 30, 60, 120, 240 kHz, respectively. The slot offsets for the two or four CSI-RS resources are configured such that the first pair of resources are transmitted in one slot, and the 2nd pair (if configured) are transmitted in the next (adjacent) slot. All four resources are single port with density 3.

Error! Reference source not found. shows an exemplary measurement timeline for a legacy CSI report with added TD/DD reporting, where the CSI-RS measurement occasions are marked as RS 1, 2, 3, . . . and the TRS measurement occasions are marked as TRS 1,2,3, . . . . The CSI reports are marked as R 1, 2, 3, . . . . The diagram of FIG. 3 represents an exemplary illustration of the relative position in time slots of CSI-RS and TRS measurement occasions with respect to a CSI report, however the time behaviour of CSI reporting may be different from the example in the diagram. For example, Type-II reporting may be semi-persistent or aperiodic and the reference signals may be configured as periodic, semi-persistent or aperiodic.

Error! Reference source not found.5 illustrates exemplary resource element locations occupied by a TRS occasion e.g. configured with four resources over two consecutive slots. A UE may be configured to determine (e.g. calculate) the normalised time correlation of the TRS signal. Error! Reference source not found. illustrates how a single TRS occasion may allow to determine (e.g. calculate) the time correlation at Nₜ=4 lags: t₂, t₅, t₇, t₉. The network may configure a minimum time unit, T, such that all the correlation lag values are a multiple of T. In the example, T=2T_{sym}, where T_{sym} is a symbol time duration and the lag values are indexed by their normalised duration, such that t₂=2T=4T_{sym}, t₅=5T=10T_{sym}, etc. Note that, in this notation, T=t₁.

In an exemplary implementation, a UE may determine (e.g. calculate) such normalised time correlation at lag tⱼ as follows:

$$r ( {t}_{j} ) = \frac{1}{{N}_{{t}_{j}}} {\sum }_{t = {τ}_{j , 0}}^{{τ}_{j , {N}_{{t}_{j} - 1}}} \frac{h ( t ) {h ( t + {t}_{j} )}^{*}}{{\vert h ( t ) \vert}^{2}}$$

where h(t) is a TRS measurement at time t. The time correlation at lag tⱼ may be obtained by averaging over Nₜ_{ⱼ} measurements. In the example of Error! Reference source not found., r(t₂) and r(t₇) may be calculated by averaging over Nₜ_{₂}=Nₜ_{₇}=2 measurements, with {τ_{2,0}, τ_{2,1}}={4T_{sym}, 18T_{sym}} for r(t₂) and {τ_{7,0}, τ_{7,1}}={4T_{sym}, 8T_{sym}} for r(t₇). If multiple TRS occasions are configured for time and/or Doppler reporting, the averaging in the time correlation function (see above) is extended over multiple TRS measurement occasions, which may increase the measurement accuracy.

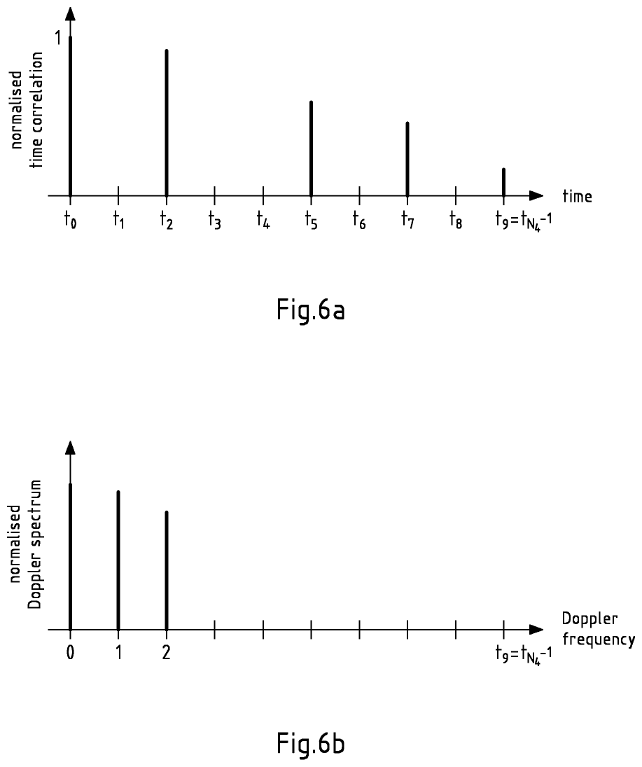

Error! Reference source not found.a and 6b illustrate an example of time correlation measured from the exemplary TRS resources of Error! Reference source not found.5. FIG. 6a illustrates an exemplary normalized time correlation and FIG. 6b a corresponding exemplary normalized Doppler spectrum. It also illustrates the relationship between time correlation and Doppler spectrum obtained by applying the Doppler-domain basis components defined by the Doppler codebook. The maximum lag of the time correlation normalised by the time unit T may provide the length, N₄, of the Doppler-domain basis components, i.e.

$${N}_{4} = \frac{max time correlation lag}{time unit T}$$

In practice, the value of N₄ may be configured by the size of the Doppler-domain basis vectors, and the time unit T may be configured as a multiple of a symbol duration, T_{sym}.

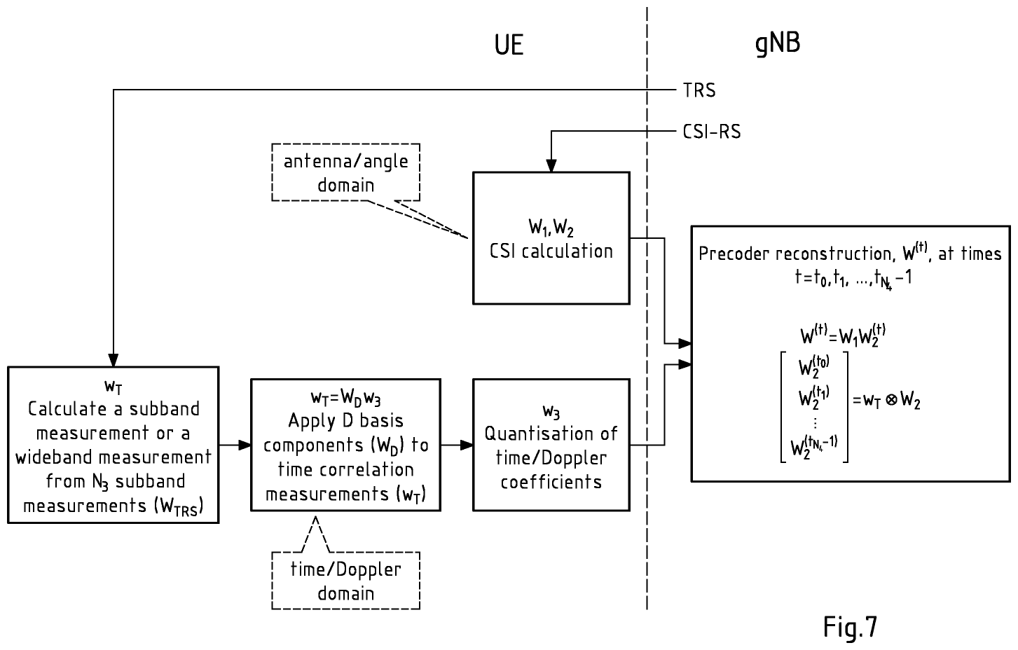

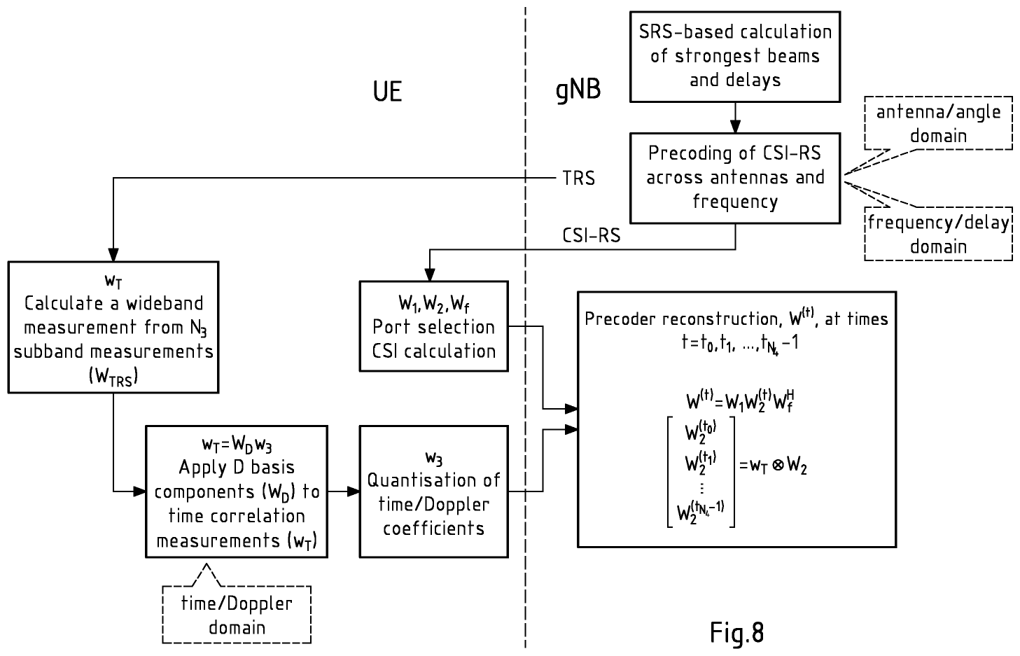

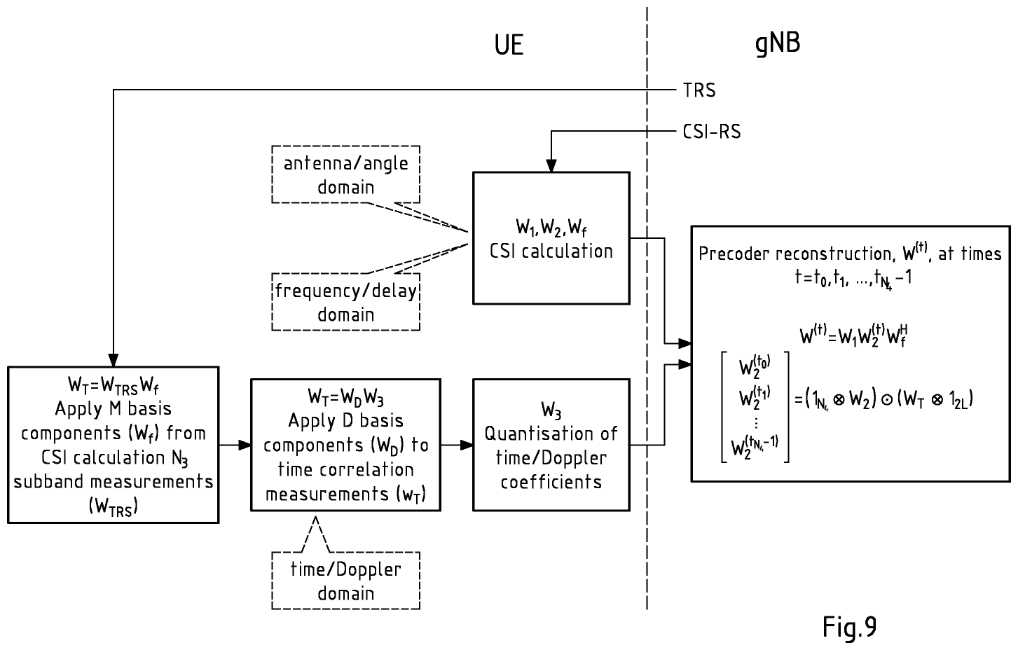

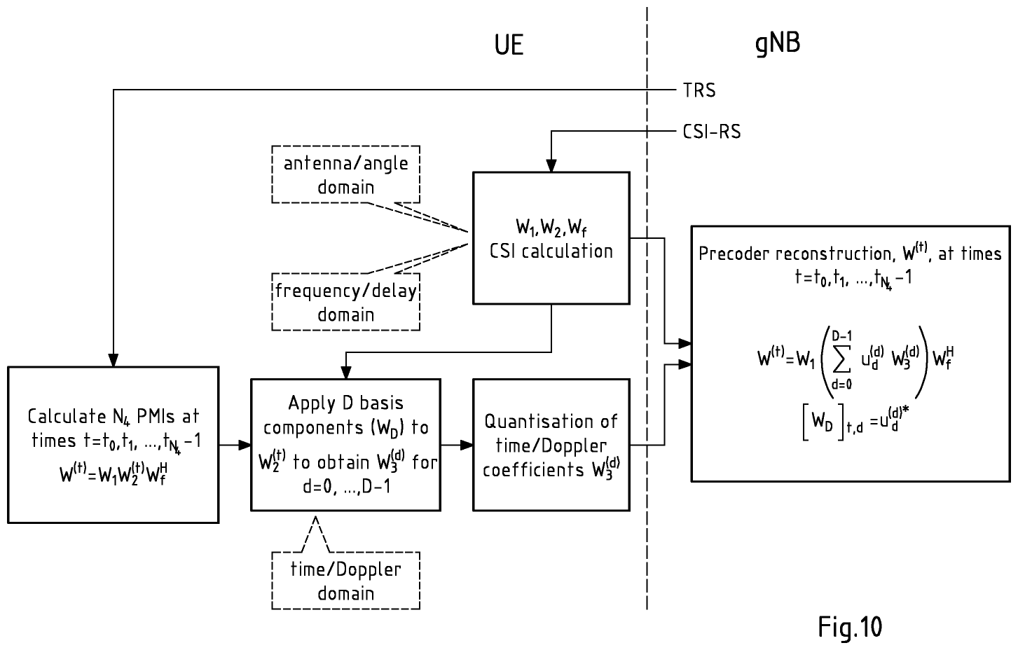

Error! Reference source not found., Error! Reference source not found., FIG. 9 and FIG. 10 show high level block diagram of an exemplary method according to the first exemplary aspect and an exemplary method according to the second exemplary aspect. Exemplary embodiments of the method according to the first aspects are depicted on the right and exemplary embodiments of the method according to the second aspect are depicted on the left. FIG. 7, FIG. 8 FIG. 9, and FIG. 10 illustrate an interaction of both methods, e.g. between the UE and gNB side.

For example the method according to the first exemplary aspect may comprise calculating at least one subband measurement or at least one wideband measurement e.g. from several subband measurements. The method according to the first exemplary aspect may further comprise applying basis component to time correlation measurements, e.g. in the time/Doppler domain, and/or quantizing time and/or Doppler coefficients. For example the method according to the first exemplary aspect may further comprise calculating CSI, e.g. based on or in the antenna/angle domain and/or the frequency/delay domain, and/or may further comprise calculating port selection CSI. For example the method according to the first exemplary aspect may further comprise calculating PMIs, e.g. a certain number, e.g. N₄, PMIs at certain times. For example the method according to the second exemplary aspect may comprise reconstructing a precoder. For example the method according to the second exemplary aspect may further comprise SRS-based determining (e.g. calculating) of strongest beams and delays and/or precoding CSI-RS across antennas and/or frequencies e.g. in the antenna/angle domain or frequency/delay domain. For example a precoder may be as described above or below and/or at least one of:

$$\begin{matrix}{W}^{( t )} = {W}_{1} {W}_{2}^{( t )} ; \\ {W}^{( t )} = {W}_{1} {W}_{2}^{( t )} {W}_{f}^{H} ; \\ {W}^{( t )} = {W}_{1} ( {\sum }_{d = 0}^{D - 1} {u}_{d}^{( d )} {W}_{3}^{( d )} ) {W}_{f}^{H} ,\end{matrix}$$

wherein W₁, W₂, W₃, W_{f}, u_{d} may e.g. be of any type defined in this description.

In particular, Error! Reference source not found., Error! Reference source not found., FIG. 9, and FIG. 10 show high level block diagrams of an exemplary CSI calculation with additional time and/or Doppler domain information at the UE and how a precoder respectively precoder matrix may be obtained from the CSI quantities. In the exemplary schemes, the precoder matrix at time t=t₀ may be provided by the legacy CSI. The precoder matrices at times t=t₁, t₂, . . . , t_{N}_{₄}₋₁ may be obtained by combining a legacy CSI report (Type I or Type II), measured from or based on CSI-RS and additional time and/or Doppler domain information measured from TRS. The TRS-based time correlation/Doppler domain feedback may be used to obtain the variation in time of the nonzero combination coefficients (W₂), whereas the SD and FD basis components (W₁ and W_{f}, respectively) may be e.g. assumed the same for the N₄ precoders. In some exemplary embodiments, a UE may be configured to report the Nₜ samples of the time correlation e.g. such that the Doppler-domain compression operation is omitted.

In one exemplary configuration, the TRS measurements in time/Doppler domain may be used to estimate the variation in time separately for a respective (e.g. each) subband in the CSI reporting band and a UE reports the time/Doppler quantities (i.e. the time domain and/or Doppler domain information) in a subband fashion. In another exemplary configuration, the time/Doppler domain quantities may be assumed wideband, i.e., common for all channel delays taps corresponding to the FD components selected in the CSI-RS-based PMI calculation. For example, in this case, a UE may report time/Doppler related quantities in a wideband fashion. In a further exemplary configuration, the TRS measurements in time/Doppler domain may be used to estimate the variation in time for at least one (e.g. each) of the FD basis components selected in the CSI-RS-based PMI calculation. For example, in this case, a UE may report separate time/Doppler domain quantities for multiple FD basis components.

For example, let W_{TRS} be an N₄×N₃ matrix containing the time correlation measurements, r(tⱼ), for a respective (e.g. each) subband and Nₜ lag values. N₄-Nₜ rows of W_{TRS} may be zero, if direct measurement at the corresponding lag value is not available. In case of wideband time/Doppler reporting, such as illustrated in Error! Reference source not found. and Error! Reference source not found., wideband time correlation values may be determined (e.g. calculated) from the subband measurement for the Nₜ lag values and are arranged in an N₄×1 vector, W_{T}.

In case of subband time/Doppler reporting, such as in Error! Reference source not found., the M FD basis components selected by the legacy Type-II CSI calculation and represented by an N₃×M DFT matrix W_{f}, may be applied to W_{TRS} to obtain the FD-transformed time-correlation matrix W_{T}=W_{TRS}W_{f}.

In an exemplary embodiment, the time correlation values may be reported without Doppler compression, such that the nonzero elements of W_{T}, for wideband TD reporting, or the nonzero elements of W_{T}, for subband TD reporting, are reported by the UE.

In another exemplary embodiment a Doppler compression codebook is configured, which is formed by length-N₄ basis vectors. D vectors from the codebook, referred to as DD basis components, may be configured by the network or selected by a UE. These vectors may be arranged in a N₄×D matrix W_{D} and applied to W_{T} or W_{T} to obtain the DD combination coefficients. For wideband DD reporting, these coefficients my be represented by a D×1 vector, W₃=w_{T}W_{D}^{H}. For subband DD reporting, these coefficients may be represented by a D×M matrix, W₃=W_{T}W_{D}^{H}. Before applying the DD transformation, a UE may apply interpolation to the Nₜ nonzero correlation values such that all N₄ lags contain nonzero correlation values.

The gNB may receive a legacy CSI, from which a precoder matrix for a layer l may be obtained as

$$W = {W}_{1} {W}_{2}$$

For Type-I reporting, or as

$$W = {W}_{1} {W}_{2} {W}_{f}^{H}$$

for Type-II reporting. Additionally, the gNB may, for example, receive the time correlation coefficients, W_{T} for wideband TD reporting, or W_{T}, for subband TD reporting, and/or the DD combination coefficients associated to the D basis components, w₃ for wideband DD reporting, or W₃ for subband DD reporting. In case of DD reporting, the gNB may reconstruct the TD correlation function by applying the decompression operation w_{T}=W_{D}w₃ or W_{T}=W_{D}W₃, for wideband and subband reporting, respectively. For example, finally, the precoder may be reconstructed at time t=t₀, t₁, . . . , t_{N}_{₄}₋₁ (e.g. t₀=0), e.g. as follows for wideband reporting

$${W}^{( t )} = {W}_{1} {W}_{2}^{( t )} or {W}^{( t )} = {W}_{1} {W}_{2}^{( t )} {W}_{f}^{H}$$

with

$$[ \begin{matrix}{W}_{2}^{( {t}_{0} )} \\ {W}_{2}^{( {t}_{1} )} \\ ⋮ \\ {W}_{2}^{( {t}_{{N}_{4} - 1} )}\end{matrix} ] = {w}_{T} ⊗ {W}_{2}$$

or e.g. as follows for subband reporting

$${W}^{( t )} = {W}_{1} {W}_{2}^{( t )} {W}_{f}^{H}$$

with

$$[ \begin{matrix}{W}_{2}^{( {t}_{0} )} \\ {W}_{2}^{( {t}_{1} )} \\ ⋮ \\ {W}_{2}^{( {t}_{{N}_{4} - 1} )}\end{matrix} ] = ( {1}_{{N}_{4}} ⊗ {W}_{2} ) ⊙ ( {W}_{T} ⊗ {1}_{2 L} )$$

where ⊗ denotes the Kronecker product and ⊙ the Hadamard or elementwise product.

Error! Reference source not found. illustrates in an exemplary block diagram of how subband or wideband TRS-based time/Doppler domain reporting may be combined to Type I or Type II subband or wideband CSI reporting, respectively.

UE may calculate N₄ time-domain subband measurements, W_{T}, from TRS for a respective (e.g. each) subband s, with s=0, . . . , N₃−1. A UE may interpolate Nₜ≤N₄ time correlation lags to obtain N₄ samples. Alternatively, the UE may calculate N₄ wideband measurements, W_{T}, from the N₄×N₃ TRS correlation measurements, W_{TRS}. The UE may (then) apply the D≤N₄ DD basis components (W_{D}) to a length-N₄ vector W_{T} to obtain a compressed representation of the time-domain measurements in the length-D vector W₃. These D combination coefficients may (then) be quantised and (e.g. only) the nonzero values may be reported. For the reconstruction of the PMI nonzero coefficients, W₂^{(t)} at times t=t₀, t₁, . . . , t_{N}_{₄₋₁}, it may be assumed that W_{T}, as obtained from the quantised nonzero coefficients of W₃, may be normalised such that w₂⁽⁰⁾=W₂, where W₂ is the matrix of combination coefficients reported by the PMI report.

Error! Reference source not found. illustrates in an exemplary block diagram of how wideband TRS-based time/Doppler domain reporting may be combined to FeType II port selection CSI reporting. The exemplary scheme is similar to the wideband case of Error! Reference source not found., with the difference that the wideband coefficients apply to one or both FD basis components of W_{f}, depending on gNB configuration.

Error! Reference source not found. illustrates in an exemplary block diagram how TRS-based time/Doppler domain measurement and reporting can be done separately for a respective (e.g. each) FD basis component and combined with an eType II PMI. In this case, the M FD basis components (W_{f}) selected in a/the legacy PMI calculation may be applied to the N₄×N₃ matrix of TRS measurements, W_{TRS}, to obtain an N₄×M matrix of time measurements for at least one (e.g. each) of the M components, W_{T}. The UE may (then) apply the D≤N₄ DD basis components (W_{D}) to the matrix W_{T} to obtain a compressed representation of the time-domain measurements in the D×M matrix W₃. The reconstruction formula for the combination coefficients W₂^{(t)} is similar to that of Error! Reference source not found., with the difference that different time variations are applied to each of the M columns of W₂ reported in the PMI.

FIG. 10 illustrates in another exemplary block diagram how different time/Doppler domain measurement and reporting can be done separately for a respective (e.g. each) SD and FD basis component and combined with an eType II PMI. In this case, the UE may obtain N₄ PMIs at times t=t₀, t₁, . . . , t_{N}_{₄}₋₁, corresponding to precoders W^{(t)}=W₁W₂^{(t)}W_{f}^{H}. The UE may then apply each of the D basis vectors of W_{D} to the N₄ matrices of 2L×M combination coefficients W₂^{(t)} and obtain D matrices, W₂^{(d)}, with d=0,1, . . . , D−1. The precoder matrices at times t=t₀, t₁, . . . , t_{N}_{₄}₋₁ may e.g. be expressed as follows

$$[ {W}^{( {t}_{0} )} {W}^{( {t}_{1} )} … {W}^{( {t}_{{N}_{4} - 1} )} ] = {W}_{1} [ {W}_{3}^{( 0 )} {W}_{3}^{( 1 )} … {W}_{3}^{( D - 1 )} ] ( {W}_{D}^{H} ⊗ {W}_{f}^{H} )$$

Equivalently, by denoting the element of W_{D} in row t and column d as [W_{D}]_{t,d}=uₜ^{(d)*}, where (·)* denotes complex conjugation, a precoder matrix at time t may e.g. be written as follows

$${W}^{( t )} = {W}_{1} ( {\sum }_{d = 0}^{D - 1} {u}_{t}^{( d )} {W}_{3}^{( d )} ) {W}_{f}^{H}$$

If the UE is equipped with multiple receive antennas, i.e. Nᵣₓ>1, the same or different TRS-based time/Doppler-domain quantities may be reported for a respective (e.g. each) of the v reported layers. If different time variations are measured per layer, a UE implementation may apply to the Nᵣₓ TRS measurements the same right singular vectors, of length Nᵣₓ, obtained from the SVD or EVD in the CSI-RS-based PMI calculation and used for the layer calculation. The i-th right singular vector may contain the combination coefficients that, e.g. once applied to the receive antenna ports, may yield the corresponding i-th left singular vector associated to the i-th layer of the precoder matrix.

In the above and other exemplary embodiments, the DD basis components (W_{D}) applied to the N₄ TRS measurement occasions may e.g. be configured from a DFT-based or DCT (discrete cosine transform)-based codebook. A DCT transformation may be adopted to sample the Doppler spectrum which may result in a higher accuracy in the representation of the time correlation at the edges. When compression is performed by a DFT transformation, these edge samples may be the most affected by reconstruction error because of the discontinuity of the signal to compress when extended by periodicity. The DCT may offer a solution to this problem because it eliminates this discontinuity by symmetrically extending the signal and applying a DFT on a signal of double length. Another advantage of DCT over DFT compression may be that the compressed signal samples decrease in power with the Doppler component index. Therefore, the UE may not need to feed back the DD basis components (W_{D}). Instead the gNB may configure a UE to determine (e.g. calculate) the first D components. This may save feedback overhead when using DCT-based Doppler components as compared to DCT-based codebook.

For a DCT-based codebook, the d-th codebook element may be given by a vector u^{(d)}=[u₀^{(d)}, u₁^{(d)}, . . . , u_{N}_{₄}₋₁^{(d)}]^{T}, whose entries may be defined as

$${u}_{t}^{( d )} = \{ \begin{matrix}\frac{1}{\sqrt{{N}_{4}}} , & t = 0 \\ \frac{2}{\sqrt{{N}_{4}}} cos ( π \frac{( 2 j + 1 ) t}{2 {N}_{4}} ) , & t = 1 , … , {N}_{4} - 1\end{matrix} , d = 0 , … , {N}_{4} - 1.$$

In case of a DFT-based precoder, the codebook entries may be defined as

$${u}_{t}^{( d )} = {e}^{j \frac{2 π td}{{N}_{4}}} , t , d = 0 , 1 , … , {N}_{4} - 1.$$

The index t may be associated with the time-domain whereas d may be associated with the transformed Doppler domain.

In the following, an example is provided of how the time variation of the precoder matrix may be expressed as a function of a legacy PMI report and the new time and/or Doppler domain information. For this, the exemplary reconstruction formula of Error! Reference source not found. is expanded as an example. Similar formulas may be obtained for other possible embodiments. For instance, let D≤N₄ be the number of DD components that a UE is configured to measure and f=0, . . . , M−1 the FD component index. It may be assumed that the M FD components are common across layers, e.g. as in Rel-17 port selection codebook. However, if layer specific, the DD combination coefficients may have to be determined (e.g. calculated) for the union of FD components selected across all reported layers. The amplitude of the combination coefficients associated with the D TD components, for layer l, may be indicated by

$$\begin{matrix}{q}_{l} = [ {q}_{l , 0} … {q}_{l , D - 1} ] \\ {q}_{l , d} = [ {q}_{l , 0 , d} … {q}_{l , M - 1 , d} ]\end{matrix}$$

and their phase may be given by

$$\begin{matrix}{ψ}_{l} = [ {ψ}_{l , 0} … {ψ}_{l , D - 1} ] \\ {ψ}_{l , d} = [ {ψ}_{l , 0 , d} … {ψ}_{l , M - 1 , d} ] .\end{matrix}$$

The amplitude and phase of the nonzero coefficients associated with the SD-FD basis component pairs of the legacy CSI may be indicated by p_{l,i,f} and φ_{l,i,f}, respectively, for layer l, SD component i and FD component f. The precoder expression for subband s=0, . . . , N₃−1 and layer l=1, . . . , v at time t=0, 1 . . . , N₄−1, W_{s,t}^{l}, may be expanded as follows, where {vₘ_{₁}_{⁽ⁱ⁾}ₘ_{₂}_{⁽ⁱ⁾}}, for i=0, . . . , L represent the selected SD basis components of size 2N₁N₂×1, and y_{s,l}^{(f)}, for f=0, . . . , M−1, is the s-th element of the f-th selected FD basis component

$$\begin{matrix}{W}_{s , t}^{l} = \frac{1}{\sqrt{{N}_{1} {N}_{2} {γ}_{s , l , t}}} [ \begin{matrix}{\sum }_{i = 0}^{L - 1} {v}_{{m}_{1}^{( i )} , {m}_{2}^{( i )}} {\sum }_{f = 0}^{M - 1} {y}_{s , l}^{( f )} {p}_{l , i , f} {\sum }_{d = 0}^{D - 1} {u}_{t , l}^{( d )} {q}_{l , f , d} {ψ}_{l , f , d} \\ {\sum }_{i = 0}^{L - 1} {v}_{{m}_{1}^{( i )} , {m}_{2}^{( i )}} {\sum }_{f = 0}^{M - 1} {y}_{s , l}^{( f )} {p}_{l , i + L , f} {φ}_{l , i + L , f} {\sum }_{d = 0}^{D - 1} {u}_{t , l}^{( d )} {q}_{l , f , d} {ψ}_{l , f , d}\end{matrix} ] \\ l = 1 , 2 , 3 , 4 , s = 0 , … , {N}_{3} - 1 , t = 0 , {t}_{1} … , {t}_{{N}_{4} - 1}\end{matrix} ,$$

With regard to the CQI calculation, a UE may be configured to determine (e.g. calculate) a CQI under the assumption that the downlink transmission occurs over a time period of length t_{N}_{₄}₋₁ and such that e.g. precoder W_{s,t}^{l} for subband s and layer l is applied at time t=0, t₁ . . . , t_{N}_{₄}₋₁.

As a further exemplary embodiment a method for measuring time variations of the channel from TRS signals, reporting corresponding channel state information and using this information to determine the variation in time of the nonzero combination coefficients of a legacy Type-I or Type-II PMI is disclosed. The TRS time measurements may be e.g. reported as time correlation at predetermined time lags or as transformed coefficients associated to a set of basis components taken from a codebook. The maximum time correlation lag, t_{N}_{₄}₋₁ may e.g. be determined by the maximum time separation of the measured TRS resources and the time unit T=t₁ may correspond to the fraction t_{N}_{₄}₋₁/N₄, where N₄ is the codebook dimension, and T is a multiple of a symbol duration T_{sym}. The codebook e.g. configured for the compression of the time correlation may e.g. be formed by (a) discrete cosine transformed basis.

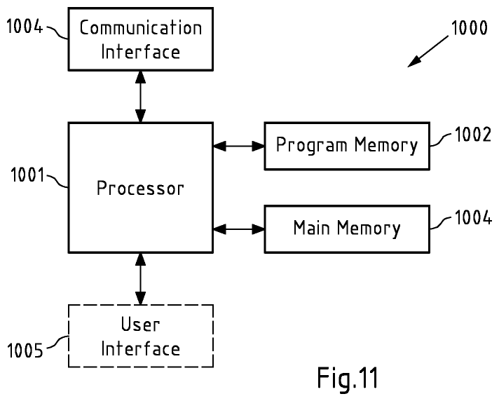

FIG. 11 is a schematic block diagram of an apparatus 1000 according to an exemplary aspect, which may for instance represent one of the apparatus 101, 102.

Apparatus 1000 comprises a processor 1001, program memory 1002, working or main memory 1003, data memory, communication interface(s) 1004, and an optional user interface 1005.

Apparatus 1000 may for instance be configured to perform and/or control or comprise respective means (at least one of 1001 to 1005) for performing and/or controlling the method according to the first and/or second exemplary aspect. Apparatus 1000 may as well constitute an apparatus comprising at least one processor (1001) and at least one memory (1002) including computer program code, the at least one memory and the computer program code configured to, with the at least one processor, cause an apparatus, e.g. apparatus 1000 at least to perform and/or control the method according to the first exemplary aspect.

Processor 1001 may for instance further control the memories 1002 to 1003, the communication interface(s) 1004, the optional user interface 1005.

Processor 1001 may for instance execute computer program code stored in program memory 1002, which may for instance represent a computer readable storage medium comprising program code that, when executed by processor 1001, causes the processor 1001 to perform the method according to the first and/or second exemplary aspect.

Processor 1001 (and also any other processor mentioned in this specification) may be a processor of any suitable type. Processor 1001 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 1001 may for instance be an application processor that runs an operating system.

Program memory 1002 may also be included into processor 1001. This memory may for instance be fixedly connected to processor 1001, or be at least partially removable from processor 1001, for instance in the form of a memory card or stick. Program memory 1002 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 1002 may also comprise an operating system for processor 1001. Program memory 1002 may also comprise a firmware for apparatus 1000.

Apparatus 1000 comprises a working memory 1003, for instance in the form of a volatile memory. It may for instance be a Random Access Memory (RAM) or Dynamic RAM (DRAM), to give but a few non-limiting examples. It may for instance be used by processor 1001 when executing an operating system and/or computer program.

Data memory may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory may for instance store one or more pieces of information e.g. a measurement on an obtained CSI-RS and/or TRS.

Communication interface(s) 1004 enable apparatus 1000 to communicate with other entities. The communication interface(s) 1004 may for instance comprise a wireless interface, e.g. a cellular radio communication interface and/or a WLAN interface) and/or wire-bound interface, e.g. an IP-based interface, for instance to communicate with entities via the Internet. Communication interface(s) may enable apparatus 1000 to communicate with other entities, for instance one or more entities as comprised by a mobile communication network

User interface 1005 is optional and may comprise a display for displaying information to a user and/or an input device (e.g. a keyboard, keypad, touchpad, mouse, etc.) for receiving information from a user.

Some or all of the components of the apparatus 1000 may for instance be connected via a bus. Some or all of the components of the apparatus 1000 may for instance be combined into one or more modules.

The disclosed exemplary aspects may allow for time domain channel tracking and/or adding time-domain correlation and/or Doppler-domain information to a legacy Type-I/eType-II CSI report, e.g. without need to measure multiple CSI-RS occasions and without requiring changes to the combination coefficients in the legacy CSI reporting. Various example embodiments may enable improved signalling.

The following embodiments shall also be considered to be disclosed:

### Embodiment 1

A method, e.g. performed by a user device, comprising:
obtaining a time domain and/or Doppler domain information, based on measuring time variations of a channel from tracking reference signal, TRS;
reporting the time domain and/or Doppler domain information and a channel state information, CSI, wherein the CSI is obtained by measuring on CSI reference signal, CSI-RS.

### Embodiment 2

The method according to embodiment 1 further comprising:
Obtaining a first configuration to report Nt time domain correlation values calculated from the TRS, and/or to report nonzero coefficients associated to D≤Nt Doppler domain codebook components, where Nt and D are integers.

### Embodiment 3

The method according to embodiment 2 further comprising:
Obtaining a second configuration to provide the TRS-based time domain and/or Doppler domain measurements in a wideband fashion or a subband fashion.

### Embodiment 4

The method according to embodiment 2 or 3, wherein the Doppler domain codebook components comprises discrete cosine transform, DCT, based and/or DFT based codebook components.

### Embodiment 5

The method according to any one of embodiments 1 to 4, wherein the time domain and/or Doppler domain information and the CSI are reported to the network node separately.

### Embodiment 6

The method according to any one of embodiments 1 to 5, wherein the TRS based time domain and/or Doppler domain information are reported for each layer of precoder matrix indicator reported in the CSI.

### Embodiment 7

A method, e.g. performed by a network node, comprising:
receiving time domain and/or Doppler domain information and at least one channel state information, CSI;
reconstructing a time domain function based on the time domain and/or Doppler domain information and a precoder matrix based on CSI.

### Embodiment 8

The method according to embodiment 7, further comprising:
Providing a first configuration (e.g. configuring; e.g. by the network node, e.g. to a user device) to report Nt time domain correlation values calculated from the TRS, and/or to report nonzero coefficients associated to D≤Nt Doppler domain codebook components, where Nt and D are integers.

### Embodiment 9

The method according to embodiment 8 further comprising:
Providing a second configuration (e.g. configuring; e.g. by the network node, e.g. to a user device) to provide the TRS-based time domain and/or Doppler domain measurements in a wideband fashion or a subband fashion.

### Embodiment 10

The method according to embodiment 8 or 9, wherein the Doppler domain codebook components comprises discrete cosine transform, DCT, based and/or DFT based codebook components.

### Embodiment 11

The method according to any one of embodiments 7 to 10, wherein the time domain and/or Doppler domain information and the CSI are obtained (e.g. from a user device) separately.

### Embodiment 12

The method according to any one of embodiments 7 to 11, wherein the TRS based time domain and/or Doppler domain information are obtained (e.g. from a user device) for each layer of precoder matrix indicator of the CSI.

### Embodiment 13

An apparatus comprising means for:
Obtaining a time domain and/or Doppler domain information, based on (the) measured time variations;
Reporting the time domain and/or Doppler domain information and the at least one channel state information, CSI, wherein the CSI is obtained by measuring on CSI reference signal, CSI-RS.

### Embodiment 14

The apparatus according to embodiment 13, wherein the reporting the time domain and/or Doppler domain information comprises reporting Nₜ time domain correlation values calculated from the TRS, and/or reporting nonzero coefficients associated to D≤Nₜ Doppler domain codebook components, where Nₜ and D are integers.

### Embodiment 15

The apparatus according to embodiment, wherein the reporting the time domain and/or Doppler domain information is performed in a wideband fashion or a subband fashion.

### Embodiment 16

The apparatus according to embodiment 14 or 15, wherein the reporting the time domain and/or Doppler domain information comprises reporting nonzero coefficients associated to D≤Nt Doppler domain codebook components, where Nt and D are integers, wherein the Doppler domain codebook components comprises discrete cosine transform, DCT, based and/or DFT based codebook components.

### Embodiment 17

The apparatus according to any one of embodiments 13 to 16, wherein the time domain and/or Doppler domain information and the CSI are reported separately.

### Embodiment 18

The apparatus according to any one of embodiments 13 to 17, wherein the reporting the time domain and/or Doppler domain information is performed for each layer of precoder matrix indicator reported in the CSI.

### Embodiment 19

The apparatus according to any one of embodiments 13 to 18 further comprising means for
Obtaining at least one CSI reference signal, CSI-RS, for obtaining at least one CSI and obtaining at least one tracking reference signal, TRS;
Measuring time variations of a channel based on the TRS.

### Embodiment 20

The apparatus according to any one of embodiments 13 to 19, wherein the apparatus is a user device.

### Embodiment 21

An apparatus comprising means for:
Obtaining time domain and/or Doppler domain information and at least one channel state information, CSI;
reconstructing a time domain function based on the time domain and/or Doppler domain information and a precoder matrix based on CSI.

### Embodiment 22

The apparatus according to embodiment 21 further comprising means for:
Providing a first configuration to a further apparatus, to report Nt time domain correlation values calculated from a tracking reference signal, TRS, and/or to report nonzero coefficients associated to D≤Nt Doppler domain codebook components, where Nt and D are integers.

### Embodiment 23

The apparatus according to embodiment 22 further comprising means for:
Providing a second configuration to the further apparatus, to provide TRS-based time domain and/or Doppler domain measurements in a wideband fashion or a subband fashion.

### Embodiment 24

The apparatus according to embodiment 22 or 23, wherein the Doppler domain codebook components comprises discrete cosine transform, DCT, based and/or DFT based codebook components.

### Embodiment 25

The apparatus according to any one of embodiments 21 to 24, wherein the time domain and/or Doppler domain information and the CSI are obtained separately.

### Embodiment 26

The apparatus according to any one of embodiments 21 to 25, wherein the TRS based time domain and/or Doppler domain information are obtained for each layer of precoder matrix indicator of the CSI.

### Embodiment 27

The apparatus according to any one of embodiments 21 to 26, wherein the apparatus is a radio access network, RAN, node of a mobile communication network.

### Embodiment 28

A system, comprising:
at least one apparatus of any of the embodiments 13 to 20; and
an apparatus of any of the embodiments 21 to 27.

### Embodiment 29

A computer readable medium comprising program instructions configured to perform and/or control or comprising respective means for performing and/or controlling the method of any of the embodiments 1 to 6.

### Embodiment 30

A computer readable medium comprising program instructions configured to perform and/or control or comprising respective means for performing and/or controlling the method of any of the embodiments 7 to 12.

### Embodiment 31

A tangible storage medium comprising program instructions configured to perform and/or control or comprising respective means for performing and/or controlling the method of any of the embodiments 1 to 6 and/or 7 to 12.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A. Further, the term “comprising” may be limited to “consisting of”, i.e. consisting of only the specified elements.

It will be understood that all presented embodiments are only exemplary, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The subject-matter has been described above by means of example embodiments. It should be noted that there are alternative ways and variations which are obvious to a skilled person in the art and can be implemented without deviating from the scope of the appended claims.

1-27. (canceled)

28. A method comprising:
obtaining a time domain and/or Doppler domain information, based on measuring time variations of a channel from tracking reference signal (TRS);
reporting the time domain and/or Doppler domain information and a channel state information (CSI), wherein the CSI is obtained by measuring on CSI reference signal (CSI-RS).

29. The method according to claim 28 further comprising:
obtaining a first configuration to report Nt time domain correlation values calculated from the TRS, and/or to report nonzero coefficients associated to D≤Nt Doppler domain codebook components, where Nt and D are integers.

30. The method according to claim 29 further comprising:
obtaining a second configuration to provide the TRS-based time domain and/or Doppler domain measurements in a wideband fashion or a subband fashion.

31. The method according to claim 29, wherein the Doppler domain codebook components comprises discrete cosine transform (DCT) based and/or discrete Fourier transform (DFT) based codebook components.

32. The method according to claim 28, wherein the time domain and/or Doppler domain information and the CSI are reported to a network node separately.

33. The method according to claim 28, wherein the TRS based time domain and/or Doppler domain information are reported for each layer of precoder matrix indicator reported in the CSI.

34. An apparatus comprising at least one processor and at least one memory including computer program code, the at least one memory and the computer program code configured to, with the at least one processor, cause the apparatus to at least perform:
obtaining a time domain and/or Doppler domain information, based on measured time variations;
reporting the time domain and/or Doppler domain information and the at least one channel state information (CSI), wherein the CSI is obtained by measuring on CSI reference signal (CSI-RS).

35. The apparatus according to claim 34, wherein the reporting the time domain and/or Doppler domain information comprises reporting Nt time domain correlation values calculated from the TRS, and/or reporting nonzero coefficients associated to D≤Nt Doppler domain codebook components, where Nt and D are integers.

36. The apparatus according to claim 35, wherein the reporting the time domain and/or Doppler domain information is performed in a wideband fashion or a subband fashion.

37. The apparatus according to claim 35, wherein the reporting the time domain and/or Doppler domain information comprises reporting nonzero coefficients associated to D≤Nt Doppler domain codebook components, wherein the Doppler domain codebook components comprises discrete cosine transform (DCT) based and/or discrete Fourier transform (DFT) based codebook components.

38. The apparatus according to claim 34, wherein the time domain and/or Doppler domain information and the CSI are reported separately.

39. The apparatus according to claim 34, wherein the reporting the time domain and/or Doppler domain information is performed for each layer of precoder matrix indicator reported in the CSI.

40. An apparatus comprising at least one processor and at least one memory including computer program code, the at least one memory and the computer program code configured to, with the at least one processor, cause the apparatus to at least perform:
obtaining time domain and/or Doppler domain information and at least one channel state information (CSI);
reconstructing a time domain function based on the time domain and/or Doppler domain information and a precoder matrix based on CSI.

41. The apparatus according to claim 40, wherein the at least one memory and the computer program code configured to, with the at least one processor, cause the apparatus further to perform:
providing a first configuration to a further apparatus, to report Nt time domain correlation values calculated from a tracking reference signal (TRS) and/or to report nonzero coefficients associated to D≤Nt Doppler domain codebook components, where Nt and D are integers.

42. The apparatus according to claim 41, wherein the at least one memory and the computer program code configured to, with the at least one processor, cause the apparatus further to perform:
providing a second configuration to the further apparatus, to provide TRS-based time domain and/or Doppler domain measurements in a wideband fashion or a subband fashion.

43. The apparatus according to claim 41, wherein the Doppler domain codebook components comprises discrete cosine transform (DCT) based and/or discrete Fourier transform (DFT) based codebook components.

44. The apparatus according to claim 40, wherein the time domain and/or Doppler domain information and the CSI are obtained separately.

45. The apparatus according to claim 40, wherein the TRS based time domain and/or Doppler domain information are obtained for each layer of precoder matrix indicator of the CSI.
